(19) United States
(12) Patent Application Publication
(10) Pub. No.: US 2008/0152103 A1
(43) Pub. Date: Jun. 26, 2008

(54) COMMUNICATION SYSTEM AND COMMUNICATION METHOD

(75) Inventor: Shinichi KASHIMOTO, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/956,720

(22) Filed: Dec. 14, 2007

(30) Foreign Application Priority Data
Dec. 25, 2006 (JP) 2006-0348189

(51) Int. Cl. H04M 11/00

(52) U.S. Cl. 379/93.09

(57) ABSTRACT

According to one embodiment, respective client terminals are linked to a plurality of respective telephone terminals in a communication system. A server connects the respective client terminals while associated with a voice communication between the telephone terminals, and performs various media communications. When the connected voice communication is disconnected, the client terminal disconnects a first type media communication to be synchronized with the voice communication among the connected media communications, and disconnects a second type media communication not to be synchronized with the voice communication after the second type media communication is finished.

### CROSS-REFERENCE TO RELATED APPLICATIONS

This application is based upon and claims the benefit of priority from Japanese Patent Application No. 2006-348189, filed Dec. 25, 2006, the entire contents of which are incorporated herein by reference.

### BACKGROUND

1. Field

One embodiment of the invention relates to a communication system and a communication method in which client terminals are connected while associated with a voice communication between telephone terminals, and respective media communications are performed between the respective client terminals.

2. Description of the Related Art

Conventionally, a telephone set including a storage device portion reading files on a storage medium to perform a transmission/reception of document files and data files prepared on personal computers and so on, is shown in Japanese Patent Application Publication (KOKAI) No. Hei 10-210168 (Patent Document 1). In this telephone set, a voice call is enabled at the beginning of a connection, and a line is not disconnected during a file transfer even if a telephone receiver is returned to the telephone set. It is proposed that the file transfer is performed surely by operations such that the line connection is maintained until the file transfer completes while checking transfer states, and the line is disconnected after the file transfer is completed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view showing a configuration of a visual communication system being an embodiment of a communication system according to the present invention;

FIG. 2 is an exemplary view showing the configuration of the visual communication system being an embodiment of the communication system according to the present invention;

FIG. 3 is an exemplary block diagram showing a functional configuration of a VCS server in the system in FIG. 1 in the embodiment;

FIG. 4 is an exemplary block diagram showing a functional configuration of a data terminal in the system in FIG. 1 in the embodiment;

FIG. 5 is an exemplary view showing a dual connection in the system in FIG. 1 in the embodiment;

FIG. 6 is an exemplary sequence diagram showing processes in which data terminals are connected with each other at a start time of a conference using the system in FIG. 1 in the embodiment;

FIG. 7 is an exemplary sequence diagram showing processes in which the data terminals are disconnected from one another at an end time of the conference using the system in FIG. 1 in the embodiment;

FIG. 8 is an exemplary flowchart showing processes of the data terminal receiving a third party disconnect request in the embodiment;

FIG. 9 is an exemplary flowchart showing processes of a VCS server transmitting the third party disconnect request in the embodiment; and

FIG. 10(a) is an exemplary example of a file of snapshots of conference participants stored in each data terminal, and FIG. 10(b) is an exemplary example of a file in which basic information relating to the conference is stored in the embodiment.

### DETAILED DESCRIPTION

Various embodiments according to the invention will be described hereinafter with reference to the accompanying drawings. In general, according to one embodiment of the invention, respective client terminals respectively linked to a plurality of respective telephone terminals are connected while associated with a voice communication between the telephone terminals by a server, and respective media communications are performed between the respective client terminals in a communication system. When the connected voice communication is disconnected, the client terminal receiving a disconnect instruction according to a third party call control from the server disconnects a first type media communication to be synchronized with the voice communication among the connected media communications; and disconnects a second type media communication not to be synchronized with the voice communication among the connected media communications, after an end of the second type media communication.

Hereinafter, a visual communication system 101 is described in detail as a preferred embodiment of a communication system according to the present invention with reference to the drawings.

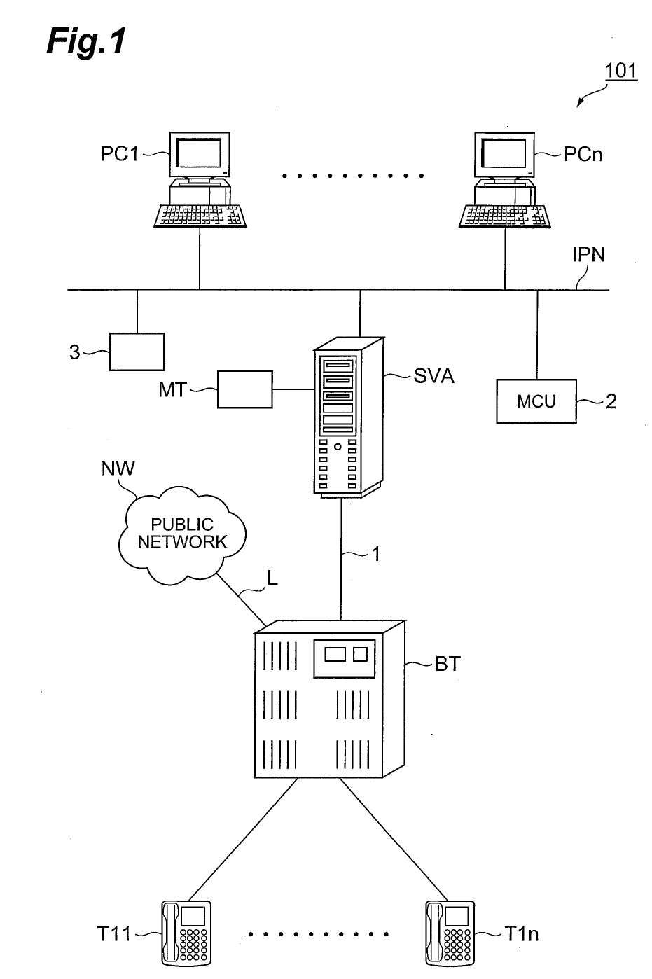

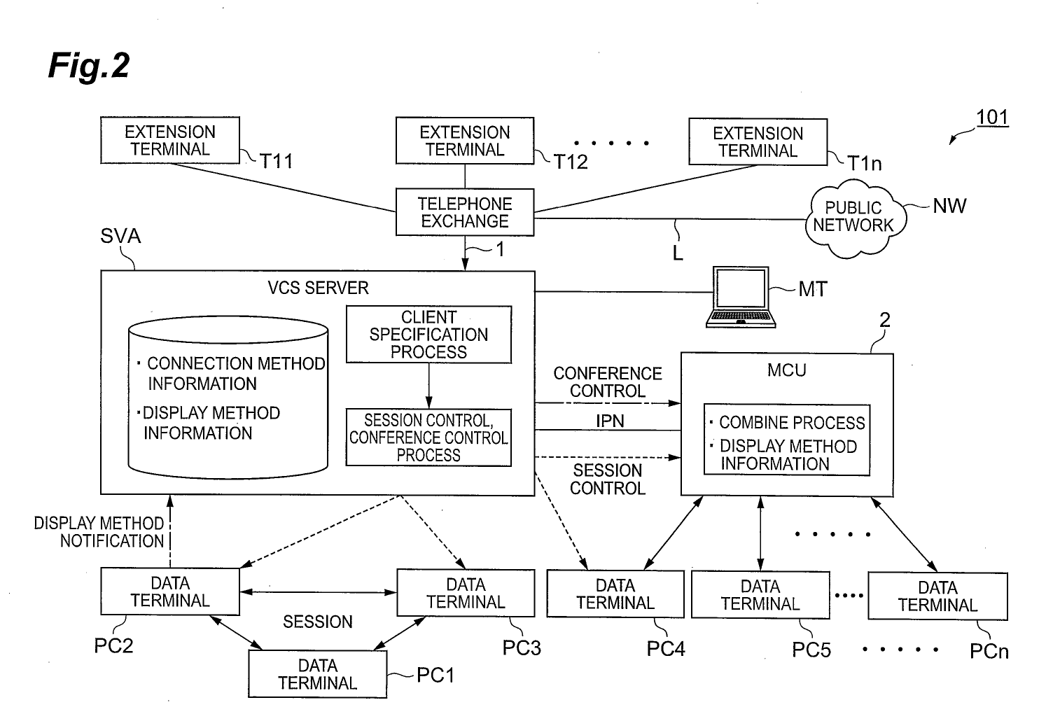

Extension terminals (telephone terminal) T11 to T1n performing a voice communication, data terminals (client terminal) PC1 to PCn performing visual related various media communications are used in the visual communication system 101 shown in FIG. 1 and FIG. 2. This system 101 realizes a visual communication performing the voice communication and the above-stated media communication between respective users simultaneously by making a connection of the extension terminals T11 to T1n of the respective users with each other and a connection of the data terminals PC1 to PCn with each other while associating them.

Namely, concretely, the data terminals PC1 to PCn as VCS clients register telephone numbers of the extension terminals T11 to T1n to be paired with themselves on a VCS server SVA. A telephone exchange BT notifies the telephone numbers of the above-stated plural extension terminals starting the voice communications to the VCS server SVA, and the VCS server SVA instructs the connections between the plural data terminals to be paired with these telephone numbers. Accordingly, the above-stated various media communications including a video communication in conjunction with dual or multipoint voice communications are enabled.

Here, usages such as a video communication transmitting/receiving moving images of users between the data terminals PC1 to PCn, a screen sharing communication sharing a screen between the data terminals PC1 to PCn, a file transfer communication transferring files between the data terminals PC1 to PCn, and an instant message communication transmitting/receiving text messages between the data terminals PC1 to PCn are possible as the above-stated media communications performed via the data terminals PC1 to PCn. Hereinafter, a case when the system 101 as stated above is used for a television conference is described as an example.

As shown in the drawing, the visual communication system 101 includes the telephone exchange BT and the VCS (Video Communication Solution) server SVA, and between these telephone exchange BT and VCS server SVA is connected via a LAN (Local Area Network) 1. The telephone exchange BT accommodates the extension terminals T11 to T1n via extension lines. Besides the telephone exchange BT is connected to a public network NW via an office line L. The telephone exchange BT performs exchange processes between the extension terminals T11 to T1n with each other, or between the extension terminals T11 to T1n and the public network NW.

The above-stated VCS server SVA accommodates the plural data terminals PC1 to PCn and an MCU 2 as a conference process portion via an IP network IPN. Each of these data terminals PC1 to PCn are constituted by general-purpose personal computers, and operate while associated with the respective extension terminals T11 to T1n. Besides, the MCU 2 performs a conference combine process between the data terminals PC1 to PCn for the above-stated video communication based on an instruction message and conference control information from the VCS server SVA. The VCS server SVA performs an additional function for the telephone exchange BT, and for example, processes media information such as video relating to the above-stated various media communications. Further, a maintenance terminal MT is connected to the VCS server SVA.

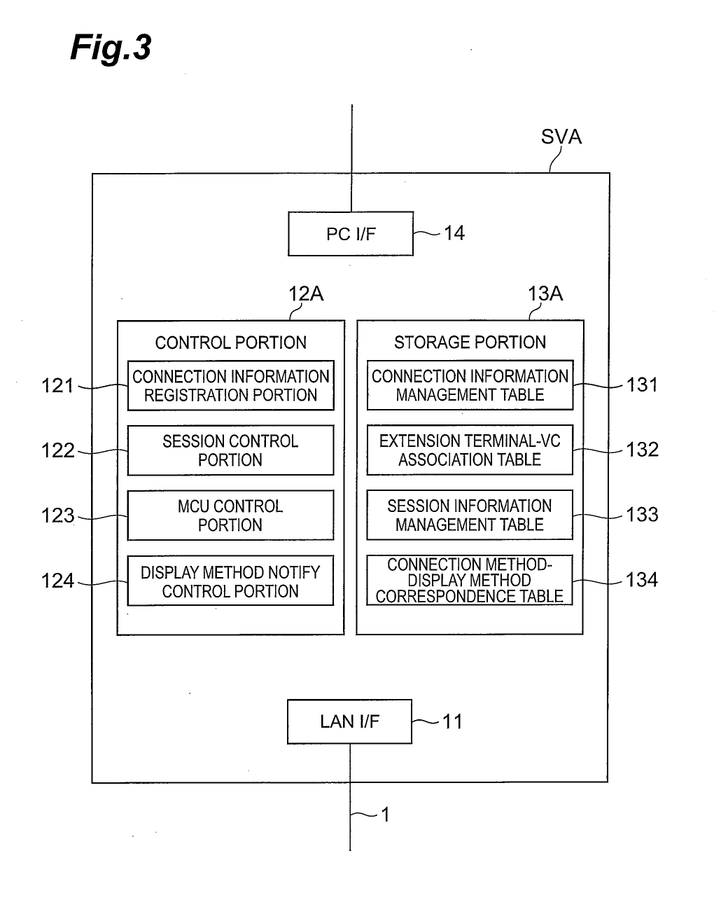

As shown in FIG. 3, the VCS server SVA includes a LAN interlace (I/F) portion 11, a control portion 12A, a storage portion 13A, and a PC interface (I/F) portion 14. The LAN interface portion 11 among them is to perform an interface process between the LAN 1. The PC interface portion 14 is to perform the interface process between the data terminals PC1 to PCn.

The storage portion 13A stores routing information and so on required for a connection control of the above-stated control portion 12A. Further, a connection information management table 131, an extension terminal-VC association table 132, a session information management table 133, and a connection method-display method corresponding table 134 are provided at the storage portion 13A. Respective telephone numbers of the extension terminals T11 to T1n, and data showing a correspondence with state information showing connection states are stored in the connection information management table 131. Data showing a correspondence between the extension terminals T11 to T1n and the data terminals PC1 to PCn are stored in the extension terminal-VC association table 132. Information showing session states between the data terminals PC1 to PCn is stored in the session management table 133.

Data showing a correspondence between a user ID, the connection method, and the display method are stored in the connection method-display method corresponding table 134. Incidentally, the connection method-display method corresponding table 134 is set by the maintenance terminal MT connected to the VCS server SVA. On the other hand, the control portion 12A includes a connection information registration portion 121, a session control portion 122, an MCU control portion 123, and a display method notify control portion 124 in addition to a state management of the data terminals PC1 to PCn and a control function relating to the association between the data terminals PC1 to PCn and the extension terminals T11 to T1n.

The connection information registration portion 121 judges that the extension terminals T11 to T1n become call state with each other by analyzing a call information event notified from the telephone exchange BT, and adds the state information of the connection information management table 131. For example, when the connection information registration portion 121 judges that the extension terminal T11 and the extension terminal T12 become in a call state, the connection information registration portion 121 adds state information of “t11-t12” to the connection information management table 131. At this time, the session control portion 122 reads out that the extension terminal T11 is associated with the data terminal PC1, and the extension terminal T12 is associated with the data terminal PC2 from the extension terminal-VC association table 132 based on the updated state information.

The session control portion 122 searches a session state of the data terminals PC1, PC2 by the session information management table 133. For example, when a call is started from that time, a session is not started at the data terminals PC1, PC2, and therefore, the session control portion 122 controls to start the sessions of the data terminals PC1, PC2. The session control portion 122 updates storage contents of the session information management table 133 when the session of the data terminals PC1, PC2 is established.

The MCU control portion 123 refers to the connection method-display method correspondence table 134 when a conference call connection between the extension terminals T11 to T1n is established. The MCU control portion 123 selectively performs a process performing a communication connection between the data terminals PC1 to PCn respectively associated with plural telephone IDs included in the call information event from the telephone exchange BT (a mesh type process), a process making the MCU 2 establish the communication connection between the data terminals PC1 to PCn respectively associated with the plural telephone IDs included in the call information event (an MCU type process) based on the reference result. Besides, the MCU control portion 123 transmits the conference control information and session control information as an instruction message separately to the MCU 2 when the MCU type process is performed by the MCU 2.

The display method notify control portion 124 notifies an individual window display method individually displaying respective plural screens of conference members for the plural data terminals PC1 to PCn to be objects at the time of the mesh type process, and notifies a common window display method displaying a screen combined at the MCU 2 for the respective plural data terminals PC1 to PCn to be objects at the time of the MCU type process. The display method notify control portion 124 refers to the connection method-display method correspondence table 134 at a switching time from the mesh type process to the MCU type process, or from the MCU type process to the mesh type process.

The display method notify control portion 124 notifies instruction information showing whether a switching is performed from the individual window display method to the common window display method or from the common window display method to the individual window display method, or the display method before the switching is maintained, for the respective plural data terminals PC1 to PCn to be the objects based on the reference result. Incidentally, the display method notify control portion 124 instructs to maintain the display method before the switching for the corresponding data terminals PC1 to PCn, if the display method is not set in the connection method-display method correspondence table 134.

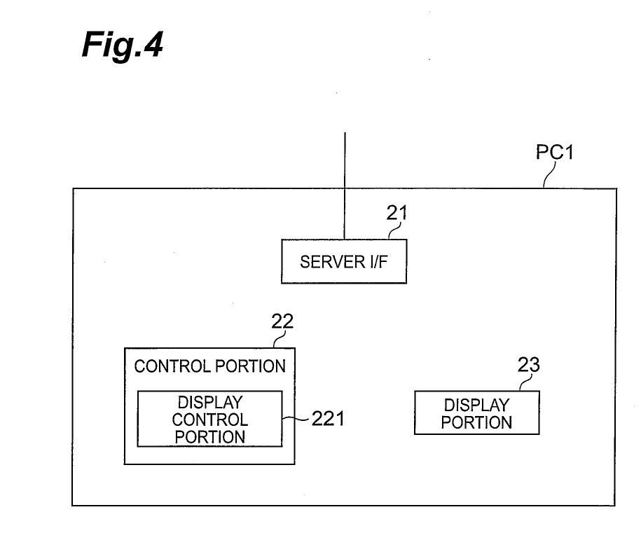

Subsequently, a functional configuration of the data terminals PC1 to PCn is described with reference to FIG. 4. All of the data terminals PC1 to PCn have equivalent configurations, and therefore, here, the data terminal PC1 is described as a representation.

The data terminal PC1 includes a server interface (I/F) portion 21, a control portion 22 and a display portion 23. Among them, the server interface portion 21 performs an interface process between the VCS server SVA. The control portion 22 includes a display control portion 221 in addition to a control function to realize operations as the data terminal PC1. The display control portion 221 displays respective screens of the conference members on the display portion 23 in the display method instructed by the VCS server SVA during a conference connection.

Subsequently, processes performing a conference in which the voice communication and the media communication are combined by using the visual communication system 101 constituted as stated above, is described.

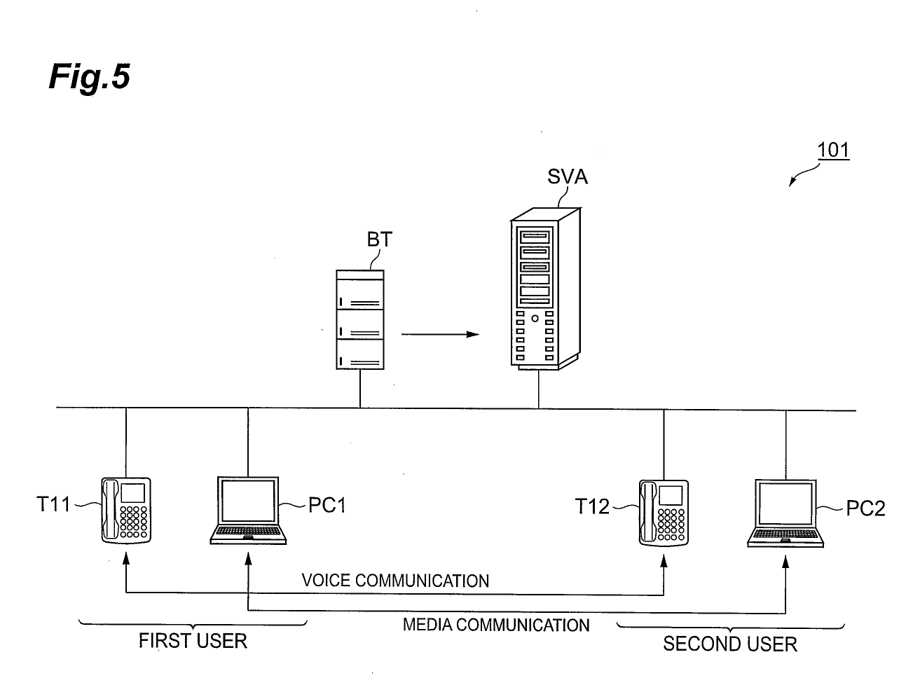

Incidentally, according to this system 101, a conference of a multipoint connection of three parties or more is possible according to the above-stated constitution, but an example of a conference of a dual connection between a first user using the extension terminal T11 and the data terminal PC1 and a second user using the extension terminal T12 and the data terminal PC2 is described as a representation in the following, as shown in FIG. 5. Besides, arbitrary telephone terminals connected to the telephone exchange BT can be used as the extension terminals T11, T12, but here, IP phone sets are to be used. Besides, a pair of the extension terminal T11 and the data terminal PC1 and a pair of the extension terminal T12 and the data terminal PC2 are equivalent on the system 101, and therefore, the data terminal PC1 and the data terminal PC2 may be shifted accordingly in the following description.

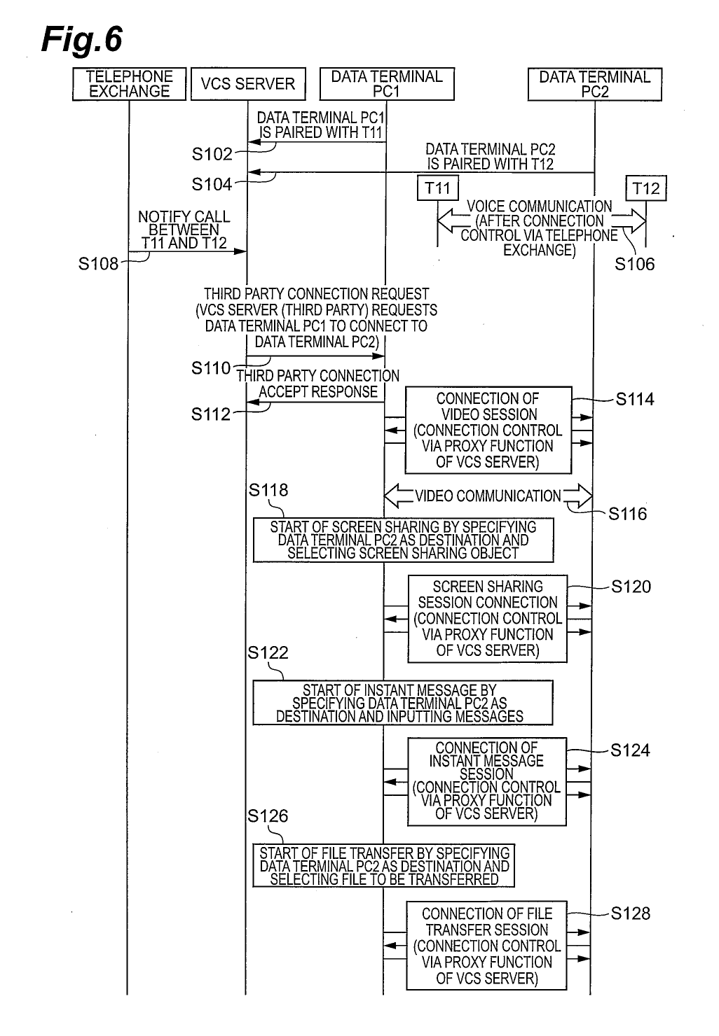

At first, the first user notifies the VCS server SVA of information showing that the data terminal PC1 and the extension terminal T11 are to be paired by an input operation to the data terminal PC1 (S102), as shown in FIG. 5 and FIG. 6. For example, the first user inputs the telephone number of the extension terminal T11 by operating the data terminal PC1. Similarly, the second user notifies the VCS server SVA of information showing that the data terminal PC2 and the extension terminal T12 are to be paired by an input operation to the data terminal PC2 (S104).

Next, when the first user makes a call to the extension terminal T12 of the second user by operating the extension terminal T11, a connection control is performed via the telephone exchange BT, and the voice communication is connected (S106) to be started. Incidentally, here, the second user may adversely make a call to the first user. At this time, the telephone exchange BT notifies the VCS server SVA that the extension terminal T11 and the extension terminal T12 are in a call state (S108).

Corresponding to this notification, the VCS server SVA transmits a third party connection request relating to a third party call control to the data terminal PC1 so that the data terminal PC1 registered as the pair of the extension terminal T11 and the data terminal PC2 registered as the pair of the extension terminal T12 are to be connected (S110). The data terminal PC1 then returns a third party connection accept response showing that the above-stated request is accepted to the VCS server SVA (S112), and establishes a session connection of a video communication between the data terminal PC2 (S114). The video communication is started between the data terminals PC1 and PC2 according to this connection (S116), and mutual video moving images of the first user and second user captured by cameras attached to the data terminals PC1, PC2 are transmitted/received between the data terminals PC1, PC2.

The video communication as stated above is preferable to be started/ended in synchronization with a start/end of the voice communication for a convenience of the user. Consequently, in this system 101, the video communication is started immediately in conjunction with the connection of the voice communication without waiting for the operations of the first user and second user as stated above.

Next, the first user performs a predetermined screen sharing start operation by the data terminal PC1 (S118), and thereby, a screen sharing session is connected between the data terminals PC1, PC2 (S120). A screen sharing function is started between the data terminals PC1 and PC2 and a display screen is shared according to this connection. It becomes possible to share conference documents and so on in real time and interactively owing to the function as stated above, and the convenience of the users in the conference is realized. In the above-stated screen sharing communication start operation, the first user is required to input information identifying the data terminal of a screen sharing destination (here, the data terminal PC2), and information specifying the screen to be shared. Consequently, this screen sharing communication is not started immediately in conjunction with the connection of the voice communication, but it is started after a start operation of the first or second user is performed.

Further, the first user performs a predetermined instant message communication start operation by the data terminal PC1 (S122), and thereby, an instant message session is connected between the data terminals PC1 and PC2 (S124). An instant message function enabling a transmission/reception of text messages and so on in real time between the data terminals PC1 and PC2 becomes usable according to this connection, and the convenience of the users in the conference is realized. The first user is required to input information identifying the data terminal of a partner (here, the data terminal PC2), and messages to be transmitted, also in the above-stated instant message communication start operation. Consequently, this instant message communication is not started immediately in conjunction with the connection of the voice communication, but it is started after the start operation of the first or second user is performed.

Further, the first user performs a predetermined file transfer start operation by the data terminal PC1 (S126), and thereby, a file transfer session is connected between the data terminals PC1 and PC2 (S128). A desired file is transferred from the data terminal PC1 to the data terminal PC2 according to this connection. For example, it becomes possible to transfer the conference documents and so on shared used in the former screen sharing communication, before the end of the conference and so on according to this function, and the convenience of the users in the conference is realized. The first user is required to input information identifying the data terminal of a transfer destination (here, the data terminal PC2), and information specifying a file to be transferred, also in the above-stated file transfer communication start operation. Consequently, this file transfer communication is not started immediately in conjunction with the connection of the voice communication, but it is started after the start operation of the first or second user is performed.

The above-stated connections of the video session, the screen sharing session, the instant message session, and the file transfer session are connection controlled via a Proxy function of the VCS server SVA. Incidentally, it is described that the first user performs the start operations by the data terminal PC1 in the above-stated three media communications of the screen sharing communication, the instant message communication, and the file transfer communication, but the second user may perform the start operations by the data terminal PC2.

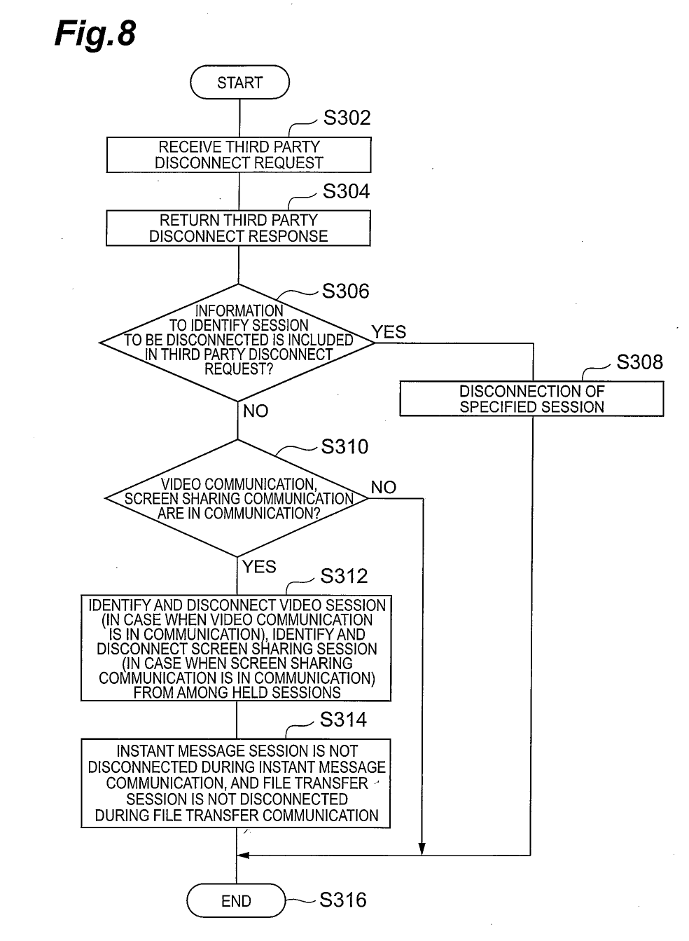

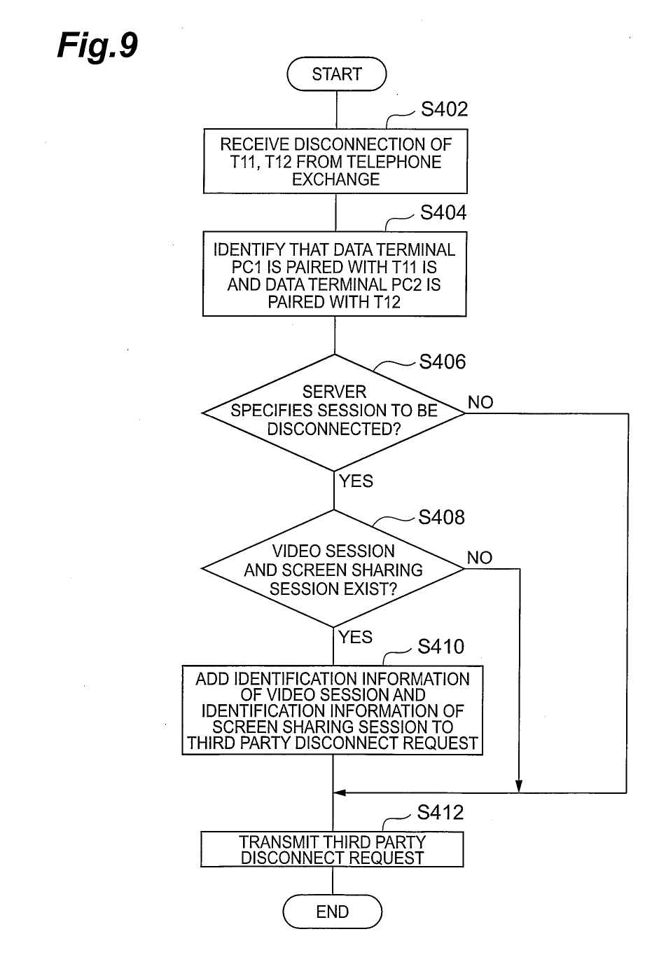

Next, processes a conference end time are described with reference to FIG. 5 and FIG. 7 to FIG. 9.

As shown in the drawings, it is assumed that the states are as follows: the voice communication is in connection between the extension terminals T11 and T12 (S202); further, four kinds of media communications of the above-stated video communication (S204), the screen sharing communication (S206), the instant message communication (S208), and the file transfer communication (S210) are in connection between the data terminals PC1 and PC2 just before the end of the conference. If the conference is finished under this state, the first or second user operates the extension terminal T11 or T12 (break the connection), and thereby, the voice communication is disconnected.

Here, there may exist two kinds of media communications to be managed differently such as the media communications to be disconnected in synchronization with the disconnection of the voice communication (hereinafter, called as “a first type media communication”) and the media communications not to be disconnected in synchronization with the disconnection of the voice communication (hereinafter, called as “a second type media communication”) among the above-stated four kinds of media communications.

For example, as it is described previously, the video communication is to be started/ended in synchronization with the start/end of the voice communication in consideration of the convenience of the users, and therefore, it is preferable to be classified into the above-stated first type media communication. Besides, the screen sharing communication is the media communication having a meaning only when it is used simultaneously with the conversation between the users, and therefore, it is preferable to be classified into the first type media communication to be disconnected in synchronization with the disconnection of the voice communication.

On the other hand, it is necessary to continue the transfer process at a background after the voice communication between the users is finished so as to transfer a file completely as for the file transfer communication because there are many cases when it takes a long time to perform the file transfer process. Accordingly, it is not adequate to disconnect the file transfer communication immediately after the disconnection of the voice communication. Consequently, it is preferable that the file transfer communication is to be classified into the second type media communication. Besides, as for the instant message communication, for example, it is preferable to be classified into the second type media communication which are not disconnected immediately after the disconnection of the voice communication so as to enable a usage in which users make a communication with each other by means of text messages after the voice communication is disconnected.

Information relating to classification such that what kind of media communication is to be classified into which type is stored in, for example, the storage portion 13A of the VCS server SVA as a media classification table, and it can be set in advance by the maintenance terminal MT. Besides, there also is a case when the media classification tables as stated above are stored in the storage portions of the respective data terminals PC1, PC2, and the above-stated classifications are judged by the respective data terminals. Incidentally, it is described below assuming that the video communication and the screen sharing communication are classified into the first type media communication, and the instant message communication and the file transfer communication are classified into the second type media communication as it is previously described as the preferred classification.

In consideration of differences of characteristics in the respective media communications, disconnection processes of the four kinds of media communications after the disconnection of the voice communication are performed as stated below in the system 101.

When the voice communication is disconnected from a state in which the above-stated four kinds of media communications are connected (S204 to S210), the telephone exchange BT notifies the VCS server SVA that the voice communication between the extension terminals T11 and T12 is disconnected (S212, S402).

The VCS server SVA identifies the data terminal PC1 registered as the pair of the extension terminal T11 and the data terminal PC2 registered as the pair of the extension terminal T12 corresponding to this notification (S404). Here, the VCS server SVA judges whether a specification of the first type media communication to be disconnected immediately among the above-stated four kinds of media communications is to be done or not (S406). When the specification is not done, the VCS server SVA transmits a third party disconnect request for the data terminal PC1 without including identification information of the media communication session (S412, S214, S302).

On the other hand, when it is judged that the specification is to be done at S406, the VCS server SVA judges whether the first type media communication (here, the video communication and the screen sharing communication) sessions exist or not (S408). Here, when it is judges as “Yes”, the VCS server SVA transmits the third party disconnect request (S412) after the above-stated session identification information of the first type media communication to be disconnected is added to the third party disconnect request to be transmitted to the data terminal PC1 (S410). Besides, when the judgment at S408 is “No”, the VCS server SVA transmits the third party disconnect request without including the identification information of the media communication session (S412, S214, S302).

This S406 is a judgment process separating whether the media communications corresponding to the first type media communication to be disconnected immediately among the four kinds of media communications are selected by the VCS server SVA by itself to specify to the data terminal PC1 or they are selected by the data terminal PC1. For example, selection object information showing whether the above-stated selection is made at the VCS server SVA or at the data terminal PC1 is stored in the storage portion 13A of the VCS server SVA to make the above-stated judgment, and the VCS server SVA can make the judgment of S406 based on this selection object information.

The data terminal PC1 receiving the above-stated third party disconnect request (S214) returns the third party disconnect accept response to the VCS server SVA (S216, S304). The data terminal PC1 then judges whether the session identification information of the first type media communication to be disconnected is included in the above-stated third party disconnect request from the VCS server SVA or not (S306). Here, when it is judged that the identification information is included, the data terminal PC1 disconnects only the sessions of the first type media communication specified by the identification information (S308). Here, only the video communication session and the screen sharing session are disconnected (S218, S220). Consequently, the sessions of the second type media communication in communication (here, the instant message communication and the file transfer communication) are not disconnected, and the data terminal PC1 is transferred to a subsequent process (S316).

On the other hand, when it is judged that the identification information is not included at S306, the data terminal PC1 judges whether the first type media communication is in communication or not (S310) When it is judged as “No” in this judgment, the data terminal PC1 transfers to the subsequent process as it is (S316). Besides, when it is judged as “Yes” in the judgment of S310, the data terminal PC1 identifies and disconnects the first type media communication in communication from among the held sessions (S312). In this case, the media classification table stored in the data terminal PC1 is referred to, the above-stated first type media communication is identified, and only the video communication session and the screen sharing session are disconnected (S218, S220). After that, the data terminal PC1 transfers to the subsequent process (S316) without disconnecting the sessions of the second type media communication in communication (S314).

Next, when the file transfer is completed (S226) from a state in which the instant message communication and the file transfer communication being the second type media communication are in communication (S222, S224) between the data terminals PC1 and PC2, the data terminal PC1 disconnects the file transfer session (S228). Besides, when an end operation of the instant message communication is performed at the data terminal PC1 or PC2 (S230), the data terminal PC1 disconnects the instant message session (S232). The disconnections of the above-stated respective sessions are disconnect controlled via the Proxy function of the VCS server SVA.

According to the system 101 as stated above, the video communication and the screen sharing communication are finished in conjunction with the voice communication, and the file transfer communication and the instant message communication are finished after the ends of the corresponding communications, in a visual communication for the partner of the voice communication. Consequently, for example, it is possible to terminate the voice communication while the file shared in the screen sharing communication is transferred. After that, the file transfer communication is disconnected automatically when the file transfer is completed, and therefore, the convenience of the user is high because the user can leave the data terminal after the voice communication is finished.

Besides, in the visual communication system 101 as stated above, the file transfer communication, the instant message communication also have a role to save a medium. Namely, the file transfer communication is a function frequently used to transfer the file after it is screen shared, and there is a request to save text messages, still images, and so on transmitted/received by using the instant message communication. The system 101 therefore has a mechanism in which the conference information as stated above is organized and saved while linking to basic information such as a conference date and time.

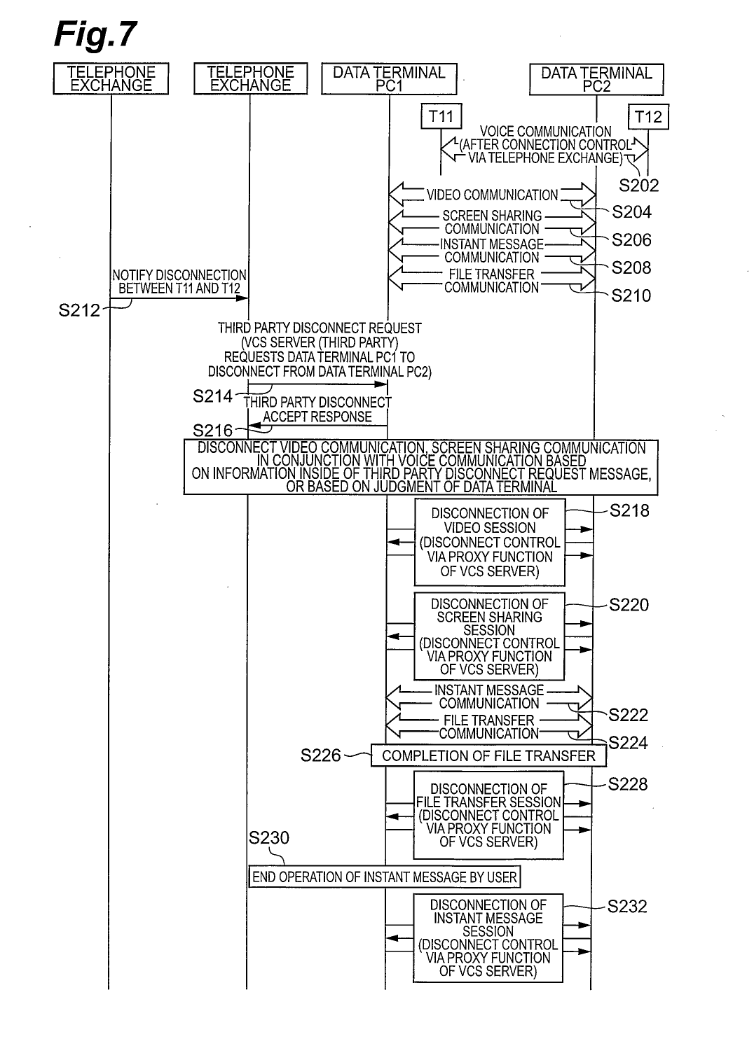

Hereinafter, an example of a conference of four point connection among four users from a first to fourth is described as a representation with reference to FIG. 6 and FIG. 7 as for a detail of the above-stated mechanism. In this case, the extension terminals T11 to T14 of the first to fourth users are registered to be paired with the data terminals PC1 to PC4 respectively. Besides, in this case, it is assumed that the respective data terminals PC1 to PC4 cannot participate in other conferences until one conference is finished (until the file transfer communication and the instant message communication are disconnected).

At first, after the voice communications among the plural extension terminals T11 to T1n are connected at a conference start time, the third party connection request is transmitted from the VCS server SVA to the data terminal PC1 to request the connection of the respective data terminals PC1 to PC4 with each other (S110). The video session connections are established among the plural data terminals PC1 to PC4 by this third party connection request, and the mutual video communications are started among the data terminals PC1 to PC4. At this time, every data terminals PC1 to PC4 obtains the current time from an NTP (Network Time Protocol) server 3 on the IP network IPN (refer to FIG. 1), and adjust internal clocks. Further, a directory named “_conf” is created at the storage portion of each of the data terminals PC1 to PC4.

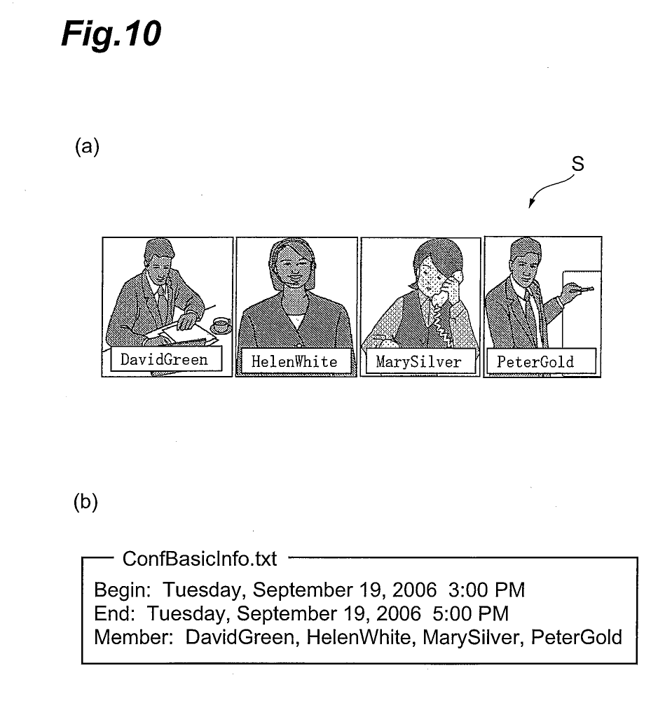

Each of the data terminals PC1 to PC4 creates a file named “ConfBasicInfo.txt” in the “_conf” directory. The current time of the internal clock is set as a “conference start date and time”, and names of the above-stated first to fourth users are recorded and saved on the above-stated “ConfBasicInfo.txt” file as “conference participant information”. Further, each of the data terminals PC1 to PC4 cuts snapshots (still image) of the first to fourth users from moving images obtained by the above-stated video communication, and saves them in the above-stated “_conf” directory as, for example, an image file named “ConfMember.bmp”. It becomes possible to save the snapshots S of the first to fourth users being the conference participants as the image file, for example, as shown in FIG. 10A by the process as stated above.

Incidentally, it becomes an issue that an adequate head shot of the user cannot be obtained because there is relatively much time when the user looks at screen shared documents and so on during the conference, and therefore, an eye view of the user is difficult to focus on a camera especially when the camera and the data terminal are kept off. Correspondingly, it is often the case that greetings and so on of the users with each other are exchanged just after the start of the conference, and therefore, a probability that the user consciously watches the camera is relatively high. In the present system 101, the snapshot S is obtained at a timing just after the start of the conference as stated above, and therefore, a possibility that the head shot of the user is obtained adequately is high.

After that, the above-stated screen sharing communication, instant message communication, and file transfer communication are started by predetermined operations of the data terminals PC1 to PC4 by the users (S116 to S128).

After that, when the voice communications among the extension terminals T11 to T14 are disconnected at the conference end time (S212), the third party disconnect request is transmitted from the VCS server SVA (S214). According to this third party disconnect request, each of the data terminals PC1 to PC4 additionally records the current time of the internal clock to the above-stated “ConfBasicInfo.txt” as the “conference end date and time”. The video communication and screen sharing communication among the respective data terminals PC1 to PC4 are disconnected (S218, S220), and only the instant message communication and file transfer communication are in the connected states (S222, S224).

After that, when the file transfer is completed (S226) and the file transfer session is disconnected (S228), the data terminals PC1 to PC4 store the file relating to this transfer into the above-stated “_conf” directory. Besides, when the instant message communication is finished (S230) and disconnected (S232) by predetermined operations of the data terminals PC1 to PC4, the data terminals PC1 to PC4 save the text messages and so on transmitted/received by the instant message function as a file into the above-stated “_conf” directory. After that, the data terminals PC1 to PC4 rename the above-stated “conf” directory into, for example, a directory name of the conference end date and time and so on. It becomes possible to create and use the “_conf” directory again at a next conference time by the rename as stated above.

According to the above-stated mechanism, a series of information relating to the conference such as the snapshots S of the conference participants (FIG. 10A), the files relating to the file transfer, and the text messages exchanged during the conference by the instant message communication, can be saved integrally while associated with the basic information such as the conference date and time, the participants, and so on (FIG. 10B).

Besides, all of the respective conference information as stated above cannot be obtained simultaneously such that the data of the conference start date and time and the snapshots can be obtained at the start time of the conference, the conference end date and time can be obtained at the end time of the conference, the files relating to the file transfer communication and the text messages of the instant message communication and so on can be obtained further later, only after the ends of the respective corresponding media communications. As stated above, it becomes possible to save the respective information obtained with time difference while associated with each other by the above-stated mechanism saving all information into the same directory in the data terminals PC1 to PC4 even when there are differences in the times obtaining the respective conference information.

Besides, the respective data terminals PC1 to PC4 obtain the current time from the NTP server 3, to perform the time adjustment of the internal clocks, and record the conference start date and time and the conference end date and time by using this internal clocks as a reference. Consequently, it becomes possible to integrate all of the information of the conference date and time recorded by each of the data terminals PC1 to PC4. Besides, a method as stated below may be used to realize the integration of the information of such conference date and time.

Namely, the VCS server SVA transmits the above-stated third party connection request (S110) while including the information of the current time. The current time of the internal clock on a computer on which the VCS server SVA is operating may by used for this current time. The data terminal PC1 receiving this third party connection request includes the above-stated current time in the connection message (S114) transmitted to the connection destination (data terminals PC2 to PC4) specified in the corresponding third party connection request. Accordingly, unified current time is notified to every data terminals PC1 to PC4, and therefore, each of the data terminals PC1 to PC4 may adjust the internal clocks based on this time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system in which respective client terminals respectively linked to a plurality of respective telephone terminals are connected while associated with a voice communication between the telephone terminals by a server, and respective media communications are performed between the respective client terminals,
wherein when the connected voice communication is disconnected, the client terminal receiving a disconnect instruction according to a third party call control from the server:
disconnects a first type media communication to be synchronized with the voice communication among the connected media communications; and
disconnects a second type media communication not to be synchronized with the voice communication among the connected media communications, after an end of the second type media communication.

2. A communication system in which respective client terminals respectively linked to a plurality of respective telephone terminals are connected while associated with a voice communication between the telephone terminals by a server, and respective media communications are performed between the respective client terminals,
wherein when the connected voice communication is disconnected, the client terminal receiving a disconnect instruction according to a third party call control from the server:
disconnects a first type media communication which is classified in advance among the connected media communications; and
disconnects a second type media communication which is classified in advance among the connected media communications, after an end of the second type media communication.

3. The communication system according to claim 1,
wherein information identifying the first type media communication to be disconnected in conjunction with the voice communication is included in the disconnect instruction from the server.

4. The communication system according to claim 1,
wherein the respective client terminals:
save primary information including a start date and time of the voice communication and information identifying the respective client terminals connected in association with the voice communication when the voice communication is connected;
additionally save information including an end date and time of the voice communication to the primary information after the disconnection of the voice communication; and
save information including information transmitted/received between the client terminals by the second type media communication while associated with the primary information.

5. The communication system according to claim 4,
wherein all of the respective client terminals obtains current time information from an NTP server at the connection time of the voice communication, and the current time is set as a reference of the start date and time and the end date and time.

6. The communication system according to claim 4,
wherein at least one of the client terminals:
obtains the current time information included in the third party connection request from the server to set the current time as the reference of the start date and time and the end date and time at the connection time of the voice communication,
transmits a connection request including the current time information for the other client terminals relating to the third party connection request, and
the other client terminals make the current time included in the connection request as the reference of the start date and time and the end date and time.

7. The communication system according to claim 4,
wherein a video communication transmitting/receiving moving images of users of the client terminals between the client terminals is included in the media communications, and
wherein the respective client terminals save:
snapshots of the users in the video communication while associated with the primary information at the start time of the video communication.

8. The communication system according to claim 4,
wherein a file transfer communication transferring files between the client terminals is included in the second type media communication, and
wherein the respective client terminals save:
the files relating to the file transfer communication while associated with the primary information after the file transfer communication is finished, when the file transfer communication is going on after the disconnection of the voice communication.

9. The communication system according to claim 4,
wherein an instant message communication between the client terminals is included in the second type media communication, and
wherein the respective client terminals save:
information transmitted/received in the instant message communication while associated with the primary information after the instant message communication is finished, when the instant message communication is going on after the disconnection of the voice communication.

10. The communication system according to claim 1,
wherein the first type media communication includes:
the video communication transmitting/receiving the moving images of the users of the client terminals between the client terminals, and a screen sharing communication sharing a screen between the client terminals, and
wherein the second type media communication includes:
the file transfer communication transferring the files between the client terminals, and the instant message communication between the client terminals.

11. The communication system according to claim 10,
wherein the video communication is started in conjunction with the start of the connection of the voice communication, and
wherein the screen sharing communication, the file transfer communication, and the instant message communication are started with corresponding to an operation of the client terminal after the connection of the voice communication.

12. A communication method, in which respective client terminals respectively linked to a plurality of respective telephone terminals are connected while associated with a voice communication between the telephone terminals by a server, and respective media communications are performed between the respective client terminals,
wherein when the connected voice communication is disconnected, the client terminal receiving a disconnect instruction according to a third party call control from the server:
disconnects a first type media communication to be synchronized with the voice communication among the connected media communications; and
disconnects a second type media communication not to be synchronized with the voice communication among the connected media communications after an end of the second type media communication.

13. A communication method, in which respective client terminals respectively linked to a plurality of respective telephone terminals are connected while associated with a voice communication between the telephone terminals by a server and respective media communications are performed between the respective client terminals,
wherein when the connected voice communication is disconnected, the client terminal receiving a disconnect instruction according to a third party call control from the server:
disconnects a first type media connection which is classified in advance among the connected media communications; and
disconnects a second type media communication which is classified in advance among the connected media communications after an end of the second type media communication.
